(19) United States
(12) Patent Application Publication
(10) Pub. No.: US 2025/0193795 A1
(43) Pub. Date: Jun. 12, 2025

(54) METHOD AND APPARATUS FOR NETWORK ENERGY SAVING WITH USER EQUIPMENT ASSISTIVE WAKING-UP

(71) Applicant: MEDIATEK INC., Hsinchu City (TW)

(72) Inventors: Wei-De WU, Hsinchu City (TW); Chien-Chun CHENG, Hsinchu City (TW); Cheng-Hsun LI, Hsinchu City (TW); Yi-Ju LIAO, Hsinchu City (TW)

(21) Appl. No.: 18/843,031

(22) PCT Filed: Mar. 30, 2023
(86) PCT No.: PCT/CN2023/085222

§ 371 Date: Aug. 30, 2024

Related U.S. Application Data
(60) Provisional application No. 63/325,167, filed on Mar. 30, 2022.

(51) Int. Cl. H04W 52/02; H04W 74/0833

(52) U.S. Cl. CPC H04W 52/0235; H04W 74/0833

(57) ABSTRACT

Various solutions for improvement of network energy saving with user equipment assistive waking-up are described. An apparatus may receive a system information (SI) from a serving network node of a wireless network. The SI indicates a sequence information. The apparatus may transmit a sequence to wake up an energy-saving network node based on the sequence information. The sequence information includes a mapping information for a measured reference signal (RS) and a measured power level.

### CROSS REFERENCE TO RELATED PATENT APPLICATION(S)

The present disclosure claims the priority benefit of U.S. Provisional Patent Application No. 63/325,167, filed on 30 Mar. 2022. The content of aforementioned application is herein incorporated by reference in its entirety.

### TECHNICAL FIELD

The present disclosure is generally related to mobile communications and, more particularly, to improvement of network energy saving with user equipment (UE) assistive waking-up.

### BACKGROUND

Unless otherwise indicated herein, approaches described in this section are not prior art to the claims listed below and are not admitted as prior art by inclusion in this section.

For current network implementations, a UE may need as much of active base stations (BSs) to maintain its transmission with a lower energy consumption. However, the network and the BSs thereof may consume too much energy if most of the BSs are operated in an active mode to serve the same UE. In addition, some scenarios, e.g., the moving UE and/or requirements for different types of transmission, may cause the BS(s) to be waked up for a longer period, which also consumes more energy.

Accordingly, how to improve network energy saving with UE assistive waking-up and efficiently cooperate with UE(s) for minimum tradeoff/impacts becomes an important issue for the newly developed wireless communication network. Therefore, there is a need to provide proper energy-saving schemes to adapt the network configurations for different traffic scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to improvement of network energy saving with UE assistive waking-up.

In one aspect, a method may involve an apparatus receiving a system information (SI) from a serving network node of a wireless network. The SI indicates a sequence information. The method may also involve the apparatus transmitting a sequence to wake up an energy-saving network node based on the sequence information. The sequence information includes a mapping information for a measured reference signal (RS) and a measured power level.

In one aspect, a method may involve a serving network node transmitting a SI to an apparatus of a wireless network. The SI indicates a sequence information. The method may also involve the serving network node receiving a sequence to wake up an energy-saving network node based on the sequence information. The sequence information includes a mapping information for a measured RS and a measured power level.

In one aspect, a method may involve an energy-saving network node receiving a waking-up indication based on a first scheme or a second scheme. The energy-saving network node is in an inactive mode. The method may also involve the energy-saving network node waking up from the inactive mode based on the waking-up indication to serve an apparatus of a wireless network.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a BS deployment in accordance with the present disclosure.

FIG. 2 is a diagram depicting an example scenario under an indirect scheme in accordance with implementations of the present disclosure.

FIG. 3 is a diagram depicting another example scenario under a direct scheme in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

FIG. 7 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of network energy saving with UE assistive waking-up. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP), a radio access network (e.g., 5G NR access network) may include a plurality of base stations (BSs) (e.g., Next Generation Node-Bs (gNBs)) to communicate with a plurality of mobile stations referred as UEs. For current network implementations, the UE may need as much of active BSs to maintain its transmission with a lower energy consumption. However, the network and the BSs thereof may consume too much energy if most of the BSs are operated in an active mode to serve the same UE. In addition, some scenarios, e.g., the moving UE and/or requirements for different types of transmission, may cause the BS(s) to be waked up for a longer period, which may consume more energy.

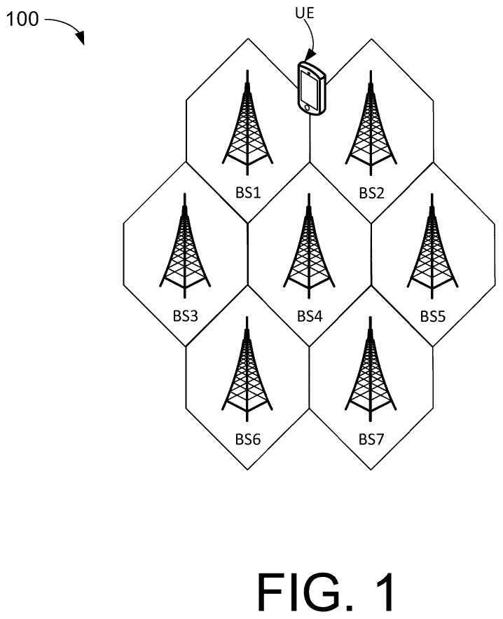

FIG. 1 illustrates an example scenario 100 of a BS deployment in accordance with the present disclosure. As shown in scenario 100, there is a BS group including seven BSs (i.e., BS1-BS7) to serve the UE within their coverage. For network energy-saving concerns, the BS1-BS7 may not be simultaneously operated in an active mode. In one example, if the BS4 is operated in the active mode and the BS1-BS3 and BS5-BS7 are in an inactive mode, the network can operate in a better network energy-saving scenario, but the UE may require more energy consumption to maintain its efficient transmission/connection. In another example, if the BS2, BS3, and BS7 are operated in the active mode and the BS1 and BS4-BS6 are in the inactive mode, lower UE energy consumption may be anticipated, but more network energy consumption may occur in comparison with the scenario having only one BS in the active mode. In addition, for a tradeoff between energy-saving concerns and efficient transmission, the network should adaptively configure the nearby BS to be waked up for serving the UE while the UE is moving. Thus, it is important for the network to apply an assistive waking-up mechanism of the UE for determining which BS should be waked up for timely serving the UE.

In some implementations, two schemes are proposed to configure the UE for performing the assistive waking-up mechanism so as to wake up a nearby and inactive BS via a waking-up indication for timely serving the UE with lower network energy consumption. Specifically, the first scheme is an indirect scheme that the UE may transmit a sequence via a physical random access channel (PRACH) to its serving BS, and the serving BS may determine a location of the UE to wake up one nearby and inactive BS (called an energy-saving BS) for serving the UE. The second scheme is a direct scheme that the UE may refer to a nearby information from the serving BS, and then transmit a preamble via the PRACH to wake up the energy-saving BS. As that, these two schemes are designed to wake up nearby and less BS (i.e., a minimum number of BS being waked up) for serving the UE and/or for the moving UE, so as to improve of the network energy saving. In some implementations, the serving BS may adaptively configure the UE with the first scheme or the second scheme for performing the assistive waking-up mechanism. In some implementations, the UE may also be configured both the first scheme and the second scheme, and the UE may determine by itself whether to apply the first scheme or the second scheme based on some default conditions (e.g., a UE capability, quality of service (QOS) and/or channel state information (CSI) corresponding to transmission, a number/threshold of radio link failure (RLF), etc.).

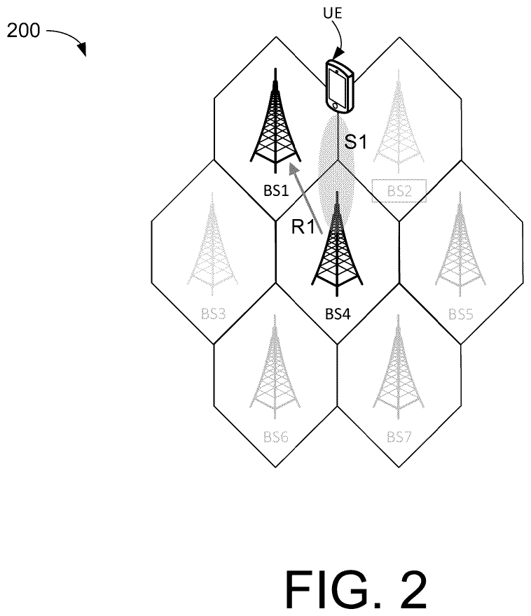

FIG. 2 illustrates an example scenario 200 under an indirect scheme in accordance with implementations of the present disclosure. As shown in scenario 200, the BS4 is configured to serve the UE and other BSs (e.g., BS1-BS3 and BS5-BS7) are in the inactive mode. In some implementations, the serving BS (e.g., BS4) may transmit an SI to the UE, and the SI indicates a sequence information that includes a mapping information indicating a direction mapping and a distance mapping. Specifically, the mapping information may include at least a first mapping table/information to specify the direction mapping for a beam realization corresponding to a reference signal (RS) synchronization signal/physical broadcast channel block (SSB) transmitted from the serving BS to the UE. The RS/SSB may be a beam out of a burst (including a plurality of beams corresponding to different directions) with a beam index (e.g., SSB2) along with a specific direction. In addition, the mapping information may include at least a second mapping table/information to specify the distance mapping for a power level of a radio signal between the serving BS and the UE.

In some implementations for the indirect scheme, the UE may transmit a sequence S1 to the serving BS4 after receiving the SI. Specifically, during transmission from the serving BS4 to the UE, the UE may receive one specific RS/SSB (e.g., SSB2) from the serving BS with a corresponding measured power level. Then, the UE may refer to the sequence information to look up the direction mapping as well as the distance mapping for the specific RS/SSB from the serving BS. Next, the UE may correspondingly transmit the specific sequence S1 to indicate to the serving BS4 its location based on the direction mapping as well as the distance mapping from the sequence information. Since the sequence S1 indicates (e.g., implicitly or explicitly) a direction from the UE to the serving BS4 and a distance between the UE and the serving BS4, the serving BS4 may precisely determine the location of the UE (or the moving UE) by receiving the sequence S1 from the UE.

In some implementations for the indirect scheme, when the serving BS4 determines the location of the UE, the serving BS4 may determine which BS in the BS group (e.g., BS1) is the nearby and inactive BS (e.g., energy-saving BS1) based on a default location information of the BS group. As that, the serving BS4 may transmit a request R1 to wake up the inactive BS1 for serving the UE, where the request R1 may be a wireless signaling or a wired signaling based on different network designs, which is not limited hereinafter.

In some implementations for the indirect scheme to wake up the energy-saving BS1, when the UE is in a connected mode with the serving BS4, the serving BS4 may transmit a handover command to the UE to prepare a handover from the serving BS4 to the energy-saving BS1. In some implementations for the indirect scheme to wake up the energy-saving BS1, when the UE is in a connected mode and performs a recovery process to the serving BS4 via the same PRACH transmitting the sequence S1, the serving BS4 may transmit a first termination to the UE to terminate the recovery process. In some implementations for the indirect scheme to wake up the energy-saving BS1, when the UE is in an idle mode or in the connected mode and the UE performs a random access channel (RACH) update process or a Timing Advance (TA) process to the serving BS4 via the same PRACH transmitting the sequence S1, the serving BS4 may transmit a second termination to the UE to terminate the RACH update process or the TA process. Thus, more processes may be simultaneously performed during the UE assistive waking-up mechanism.

In some implementations, the serving BS4 may transmit at least one of a tracking reference signal (TRS) and an SSB index, so as to increase a beam direction mapping for the mapping information. Specifically, an additional sequence size may be increased with a finer beam direction mapping by utilizing at least one of the TRS and the SSB index. In some implementation, the serving BS4 may transmit a finer granularity of the power level for the radio signal between the serving BS4 and the UE so as to increase a power-level mapping of the mapping information. In other words, another additional sequence size may also be increased with the finer granularity of the power level. As that, by increasing the sequence size with the more mapping information, the serving BS4 may accurately identity the location of the UE and efficiently wake up the nearby and inactive BS (e.g., energy-saving BS1) to serve the UE so as to improve of the network energy saving.

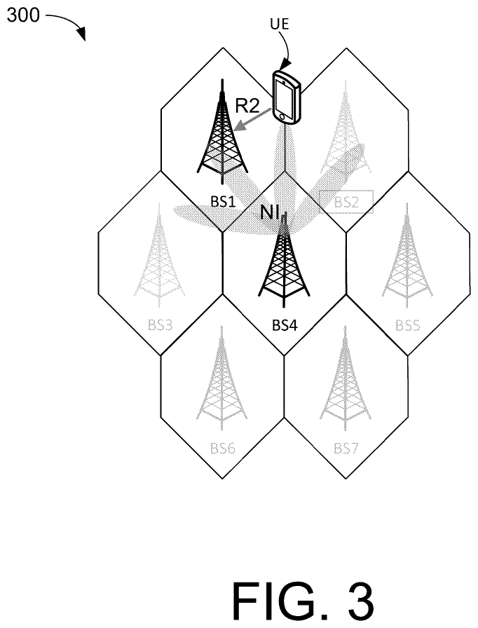

FIG. 3 illustrates another example scenario 300 under a direct scheme in accordance with implementations of the present disclosure. As shown in scenario 300, it shares the similar assumptions as utilized in scenario 200, i.e., the BS4 serving the UE with other BSs (e.g., BS1-BS3 and BS5-BS7) in the inactive mode. In addition, the serving BS4 may transmit the SI to the UE and broadcast the nearby information NI for the nearby BSs (e.g., BS1-BS3 and BS5-BS7) and the UE. Specifically, the nearby information NI includes a RACH information and a corresponding configuration between the serving BS4 and the UE. As that, the UE may receive the SI indicating the similar sequence information with its mapping information, as illustrated in scenario 200, and determine which inactive BS is the nearby BS (e.g., energy-saving BS1) by exploiting the nearby information NI and the SI.

In some implementations, after determining the nearby and inactive BS (e.g., energy-saving BS1), the UE may transmit the preamble R2 via the PRACH based on the configuration of the RACH information to the nearby and inactive BS (e.g., energy-saving BS1) for waking up. For the nearby and inactive BS (e.g., energy-saving BS1), it may need to monitor the preamble/RACH scheduled by the nearby information NI. Accordingly, the UE may directly wake up the nearby and inactive BS (e.g., energy-saving BS1) via the preamble R2 by performing an initial access to the nearby and inactive BS (e.g., energy-saving BS1), which may require less network energy consumption by waking up only one nearby BS to serve the UE.

In some implementations for the direct scheme to wake up the energy-saving BS1, the UE may indicate at least one of an urgency indication, a nearby indication, and an access assistance indication by the preamble to the energy-saving network node. In one example, the urgency indication may indicate a small power level of the measured RS as occurring an urgent event of the UE (e.g., the measured power from the active BS is weak). When the nearby and inactive BS (e.g., the energy-saving BS1) receive the preamble indicating the urgency event of the UE, the nearby and inactive BS (e.g., the energy-saving BS1) may determine to wake up and serve the UE for its urgency event.

In another example, the nearby indication may indicate a nearby beam, and the nearby and inactive BS (e.g., energy-saving BS1) may determine whether the preamble R2 transmitted from the UE can match the nearby beam. When the preamble R2 transmitted from the UE matches the nearby beam, the nearby and inactive BS (e.g., energy-saving BS1) may wake up to serve the UE.

In another example, the access assistance indication may indicate a relative location of the UE based on the preamble R2 from the UE and the pre-configured sequence information. When the relative location of the UE is determined based on the preamble R2 and the sequence information (via the above similar approach to look up the mapping information for the sequence), the nearby and inactive BS (e.g., energy-saving BS1) may determine how to wake up to respond to the UE (e.g., quick response to the UE based on the relative location of the UE). As that, the UE may direct transmit the preamble R2 as the sequence with more assistive indication to the nearby and inactive BS so as to directly wake up the nearby and inactive BS (e.g., energy-saving BS1) if the nearby and inactive BS (e.g., energy-saving BS1) accepts the initial access of the UE.

Based on the above, both the first scheme and the second scheme use only few nearby BSs to serve the UE, the network energy consumption can be effectively reduced. For the moving UE, the serving BS can also determine the latest location of the UE, and adaptively wake up the nearby and inactive for serving the UE. Accordingly, the UE assistive waking-up mechanism can effectively save more energy consumption for the network.

### Illustrative Implementations

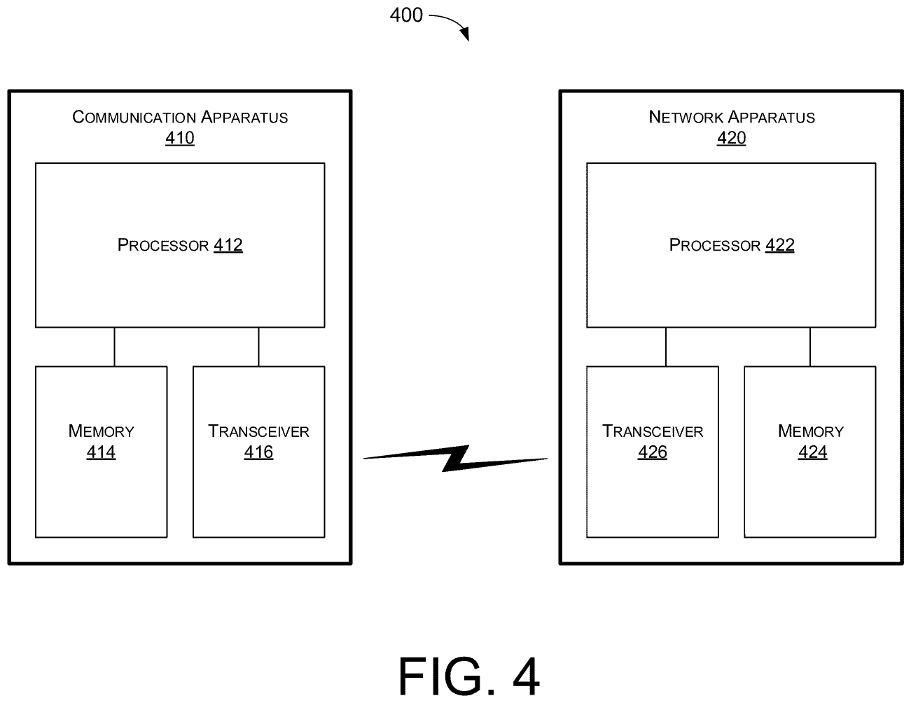

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to improvement of network energy saving with UE assistive waking-up, including scenarios/schemes described above as well as processes 500, 600, and 700 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network or in a gNB in a 5G, NR, IoT, NB-IoT or IIoT network. Specifically, the network apparatus 420 may be implemented by different functions as the serving BS and the inactive BS (i.e., the energy-saving BS), as shown in FIG. 1 to FIG. 3. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including autonomous reliability enhancements in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may receive, via transceiver 416, an SI from a serving network node, wherein the SI indicates a sequence information. Then, processor 412 may transmit, via transceiver 416, a sequence to wake up an energy-saving network node based on the sequence information, wherein the sequence information includes a mapping information for a measured RS and a measured power level.

In some implementations, processor 422 of the network apparatus 420 as a serving network node, may transmit, via the transceiver 426, an SI to an apparatus (e.g., communication apparatus 410), wherein the SI indicates a sequence information. Then, processor 422 may receive, via transceiver 426, a sequence to wake up an energy-saving network node based on the sequence information, wherein the sequence information includes a mapping information for a measured RS and a measured power level.

In some implementations, processor 422 of the network apparatus 420, as an energy-saving network apparatus, may receive, via the transceiver 426, a waking-up indication based on a first scheme or a second scheme, wherein the network apparatus 420 as the energy-saving network apparatus is in an inactive mode. Then, the processor 422 may wake up from the inactive mode based on the waking-up indication to serve the apparatus (e.g., communication apparatus 410).

### Illustrative Processes

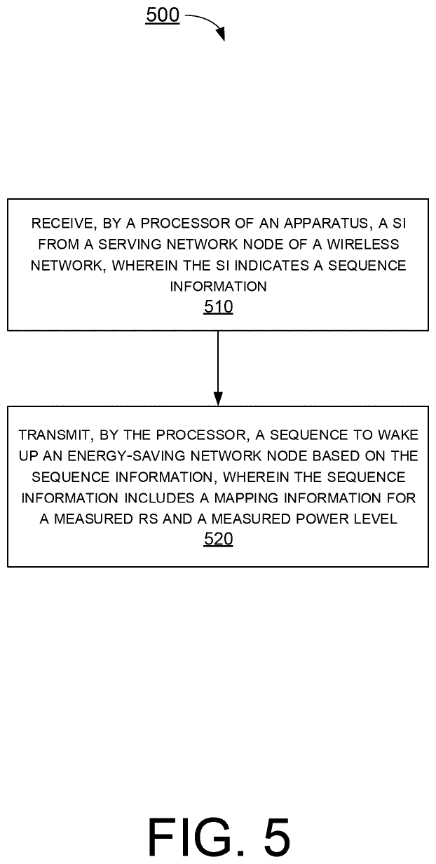

FIG. 5 illustrates an example process 500 in accordance with an implementation of the present disclosure. Process 500 may be an example implementation of above scenarios/schemes, whether partially or completely, with respect to improvement of network energy saving with UE assistive waking-up. Process 500 may represent an aspect of implementation of features of communication apparatus 410. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of communication apparatus 410 receiving a SI from a serving network node of a wireless network, wherein the SI indicates a sequence information. Process 500 may proceed from 510 to 520.

At 520, process 500 may involve processor 412 transmitting a sequence to wake up an energy-saving network node based on the sequence information, wherein the sequence information includes a mapping information for a measured RS and a measured power level.

In some implementations, process 500 may further involve processor 412 receiving at least one of a TRS and an SSB to determine a beam direction mapping; or receiving a finer granularity for the measured power level to determine a power-level mapping of the mapping information.

In some implementations, process 500 may further involve processor 412 utilizing a first scheme or a second scheme to wake up the energy-saving network node based on the mapping information, wherein the first scheme includes an indirect scheme that the communication apparatus 410 transmits the sequence via a PRACH to wake up the energy-saving network node via the serving network node based on the mapping information, and the second scheme includes a direct scheme that the communication apparatus 410 transmits a preamble via the PRACH to wake up the energy-saving network node based on a nearby information from the serving network node.

In some implementations, when the first scheme is utilized, the serving network node determines a location of the communication apparatus 410 based on a direction mapping corresponding to the measured RS and a distance mapping corresponding to the measured power level, and determines the energy-saving network node for waking up based on the location of the communication apparatus 410.

In some implementations, process 500 may further involve processor 412 receiving, in the first scheme, a handover command from the serving network node when the communication apparatus 410 is in a connected mode; receiving, in the first scheme, a first termination for a recovery process from the serving network node when the PRACH for the sequence corresponds to the recovery process and the communication apparatus 410 is in the connected mode; or receiving, in the first scheme, a second termination for a RACH update process or a TA process from the serving network node when the PRACH for the sequence corresponds to the RACH update process or the TA process and the communication apparatus 410 is in an idle mode or in the connected mode.

In some implementations, when the second scheme is utilized, the communication apparatus 410 receives the nearby information indicating a RACH information from the serving network node, and the communication apparatus 410 determines the energy-saving network node based on the nearby information and transmits the preamble based on a configuration of the RACH information to the energy-saving network node for waking up.

In some implementations, the utilizing of the second scheme to wake up the energy-saving network node based on the mapping information may involve processor 412 indicating at least one of an urgency indication, a nearby indication, and an access assistance indication by the preamble to the energy-saving network node, wherein the urgency indication indicates a small power level of the measured RS, the nearby indication indicates a nearby beam to the energy-saving network node, and the access assistance indication indicates how to respond to the communication apparatus 410 based on a relative location of the communication apparatus 410.

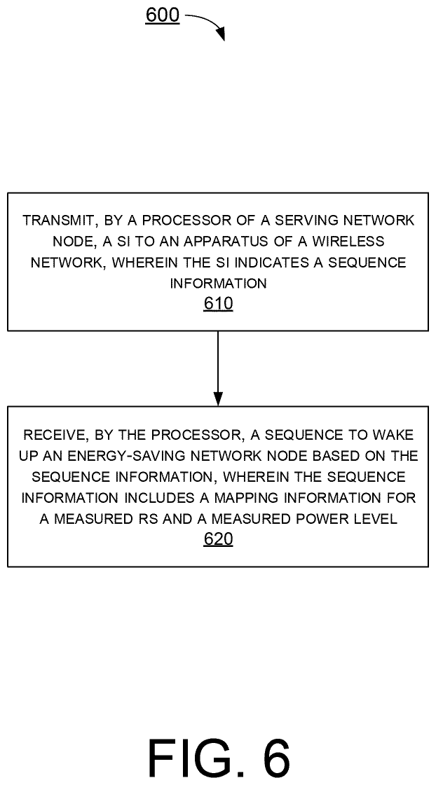

FIG. 6 illustrates an example process 600 in accordance with an implementation of the present disclosure. Process 600 may be an example implementation of above scenarios/schemes, whether partially or completely, with respect to improvement of network energy saving with UE assistive waking-up. Process 600 may represent an aspect of implementation of features of network apparatus 420 operating as a serving network node. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable BS or network nodes. Solely for illustrative purposes and without limitation, process 600 is described below in the context of network apparatus 420. Process 600 may begin at block 610.

At 610, process 600 may involve processor 422 of network apparatus 420 transmitting a SI to an apparatus (e.g., communication apparatus 410) of a wireless network, wherein the SI indicates a sequence information. Process 600 may proceed from 610 to 620.

At 620, process 600 may involve processor 422 receiving a sequence to wake up an energy-saving network node based on the sequence information, wherein the sequence information includes a mapping information for a measured RS and a measured power level.

In some implementations, process 600 may further involve processor 422 transmitting at least one of a TRS and an SSB to increase a beam direction mapping; or transmitting a finer granularity for the measured power level to increase a power-level mapping of the mapping information.

In some implementations, process 600 may further involve processor 422 utilizing a first scheme or a second scheme to wake up the energy-saving network node based on the mapping information, wherein the first scheme includes an indirect scheme that the serving network node wakes up the energy-saving network node based on the sequence transmitted by the apparatus (e.g., communication apparatus 410) via a PRACH, and the second scheme includes a direct scheme that the serving network node broadcasts a nearby information for the apparatus (e.g., communication apparatus 410) transmitting a preamble via the PRACH to wake up the energy-saving network node.

In some implementations, when the first scheme is utilized, the serving network node determines a location of the apparatus (e.g., communication apparatus 410) based on a direction mapping corresponding to the measured RS and a distance mapping corresponding to the measured power level, and determines the energy-saving network node for waking up based on the location of the apparatus (e.g., communication apparatus 410).

In some implementations, process 600 may further involve processor 422 transmitting, in the first scheme, a handover command to the apparatus (e.g., communication apparatus 410) when the apparatus (e.g., communication apparatus 410) is in a connected mode; transmitting, in the first scheme, a first termination for a recovery process to the apparatus (e.g., communication apparatus 410) when the PRACH for the sequence corresponds to the recovery process and the apparatus (e.g., communication apparatus 410) is in the connected mode; or transmitting, in the first scheme, a second termination for a RACH update process or a TA process to the apparatus (e.g., communication apparatus 410) when the PRACH for the sequence corresponds to the RACH update process or the TA process and the apparatus (e.g., communication apparatus 410) is in an idle mode or in the connected mode.

In some implementations, when the second scheme is utilized, the serving network node broadcasts the nearby information indicating a RACH information, and the apparatus (e.g., communication apparatus 410) determines the energy-saving network node based on the nearby information and transmits the preamble based on a configuration of the RACH information to the energy-saving network node for waking up.

In some implementations, when utilizing the second scheme to wake up the energy-saving network node based on the mapping information, the energy-saving network node receives at least one of an urgency indication, a nearby indication, and an access assistance indication by the preamble from the apparatus (e.g., communication apparatus 410), the urgency indication indicates a small power level of the measured RS, the nearby indication indicates a nearby beam to the energy-saving network node, and the access assistance indication indicates how to respond to the apparatus (e.g., communication apparatus 410) based on a relative location of the apparatus (e.g., communication apparatus 410).

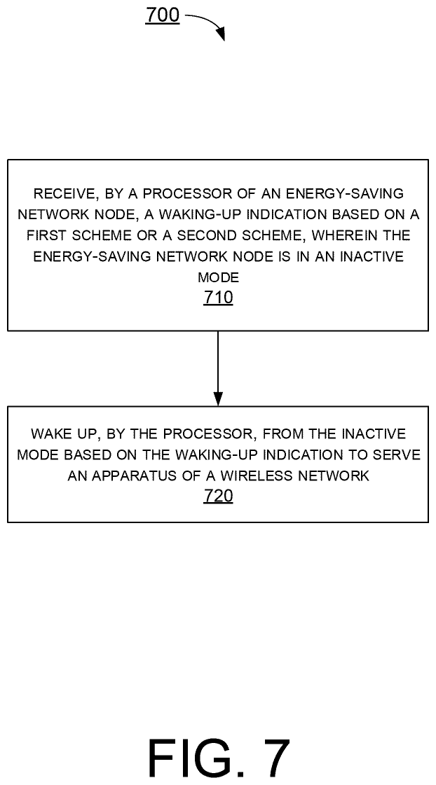

FIG. 7 illustrates an example process 700 in accordance with an implementation of the present disclosure. Process 700 may be an example implementation of above scenarios/schemes, whether partially or completely, with respect to improvement of network energy saving with UE assistive waking-up. Process 700 may represent an aspect of implementation of features of communication apparatus 410 operating as an energy-saving network node. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 420 or any suitable BS or network nodes. Solely for illustrative purposes and without limitation, process 700 is described below in the context of network apparatus 420. Process 700 may begin at block 710.

At 710, process 700 may involve processor 422 of network apparatus 410 receiving a waking-up indication based on a first scheme or a second scheme, wherein the energy-saving network node is in an inactive mode. Process 700 may proceed from 710 to 720.

At 720, process 700 may involve processor 422 waking up from the inactive mode based on the waking-up indication to serve an apparatus (e.g., communication apparatus 410) of a wireless network.

In some implementations, the first scheme includes an indirect scheme that the energy-saving network node is waked up by a serving network node based on a sequence transmitted by the apparatus (e.g., communication apparatus 410) via a PRACH and a SI transmitted by the serving network node, and the second scheme includes a direct scheme that the energy-saving network node is waked up by the apparatus (e.g., communication apparatus 410) based on a preamble transmitted by the apparatus (e.g., communication apparatus 410) and a nearby information broadcasted by the serving network node.

In some implementation, the SI indicating a sequence information is transmitted from the serving network node to the apparatus (e.g., communication apparatus 410), and the sequence information includes a mapping information for a measured RS and a measured power level.

In some implementations, the receiving of the waking-up indication may further involve processor 422 receiving, in the first scheme, the waking-up indication from the serving network node for waking up, wherein the serving network node determines a location of the apparatus (e.g., communication apparatus 410) based on a direction mapping corresponding to the measured RS and a distance mapping corresponding to the measured power level, and determines the energy-saving network node for waking up based on the location of the apparatus (e.g., communication apparatus 410).

In some implementations, the receiving of the waking-up indication may further involve processor 422 receiving, in the second scheme, the preamble via the PRACH from the apparatus (e.g., communication apparatus 410) for waking up, wherein the serving network node broadcasts the nearby information indicating a RACH information, and the apparatus (e.g., communication apparatus 410) determines the energy-saving network node based on the nearby information and transmits the preamble based on a configuration of the RACH information to the energy-saving network node.

In some implementations, the receiving of the waking-up indication may further involve processor 422 receiving, in the second scheme, at least one of an urgency indication, a nearby indication, and an access assistance indication by the preamble from the apparatus (e.g., communication apparatus 410), wherein the urgency indication indicates a small power level of the measured, the nearby indication indicates a nearby beam to the energy-saving network node, and the access assistance indication indicates how to respond to the apparatus (e.g., communication apparatus 410) based on a relative location of the apparatus (e.g., communication apparatus 410).

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a system information (SI) from a serving network node of a wireless network, wherein the SI indicates a sequence information; and
transmitting, by the processor, a sequence to wake up an energy-saving network node based on the sequence information, wherein the sequence information comprises a mapping information for a measured reference signal (RS) and a measured power level.

2. The method of claim 1, further comprising:
receiving, by the processor, at least one of a tracking reference signal (TRS) and a synchronization signal/physical broadcast channel block (SSB) index to determine a beam direction mapping; or
receiving, by the processor, a finer granularity for the measured power level to determine a power-level mapping of the mapping information.

3. The method of claim 1, further comprises:
utilizing, by the processor, a first scheme or a second scheme to wake up the energy-saving network node based on the mapping information, wherein the first scheme comprises an indirect scheme that the apparatus transmits the sequence via a physical random access channel (PRACH) to wake up the energy-saving network node via the serving network node based on the mapping information, and the second scheme comprises a direct scheme that the apparatus transmits a preamble via the PRACH to wake up the energy-saving network node based on a nearby information from the serving network node.

4. The method of claim 3, wherein when the first scheme is utilized, the serving network node determines a location of the apparatus based on a direction mapping corresponding to the measured RS and a distance mapping corresponding to the measured power level, and determines the energy-saving network node for waking up based on the location of the apparatus.

5. The method of claim 3, further comprising:
receiving, by the processor in the first scheme, a handover command from the serving network node when the apparatus is in a connected mode;
receiving, by the processor in the first scheme, a first termination for a recovery process from the serving network node when the PRACH for the sequence corresponds to the recovery process and the apparatus is in the connected mode; or
receiving, by the processor in the first scheme, a second termination for a random access channel (RACH) update process or a Timing Advance (TA) process from the serving network node when the PRACH for the sequence corresponds to the RACH update process or the TA process and the apparatus is in an idle mode or in the connected mode.

6. The method of claim 3, wherein when the second scheme is utilized, the apparatus receives the nearby information indicating a RACH information from the serving network node, and the apparatus determines the energy-saving network node based on the nearby information and transmits the preamble based on a configuration of the RACH information to the energy-saving network node for waking up.

7. The method of claim 3, wherein the utilizing of the second scheme to wake up the energy-saving network node based on the mapping information comprises:
indicating, by the processor, at least one of an urgency indication, a nearby indication, and an access assistance indication by the preamble to the energy-saving network node, wherein the urgency indication indicates a small power level of the measured RS, the nearby indication indicates a nearby beam to the energy-saving network node, and the access assistance indication indicates how to respond to the apparatus based on a relative location of the apparatus.

8. A method, comprising:
transmitting, by a processor of a serving network node, a system information (SI) to an apparatus of a wireless network, wherein the SI indicates a sequence information; and
receiving, by the processor, a sequence to wake up an energy-saving network node based on the sequence information, wherein the sequence information comprises a mapping information for a measured reference signal (RS) and a measured power level.

9. The method of claim 8, further comprising:
transmitting, by the processor, at least one of a tracking reference signal (TRS) and a synchronization signal/physical broadcast channel block (SSB) index to increase a beam direction mapping; or
transmitting, by the processor, a finer granularity for the measured power level to increase a power-level mapping of the mapping information.

10. The method of claim 8, further comprising:
utilizing, by the processor, a first scheme or a second scheme to wake up the energy-saving network node based on the mapping information, wherein the first scheme comprises an indirect scheme that the serving network node wakes up the energy-saving network node based on the sequence transmitted by the apparatus via a physical random access channel (PRACH), and the second scheme comprises a direct scheme that the serving network node broadcasts a nearby information for the apparatus transmitting a preamble via the PRACH to wake up the energy-saving network node.

11. The method of claim 10, wherein when the first scheme is utilized, the serving network node determines a location of the apparatus based on a direction mapping corresponding to the measured RS and a distance mapping corresponding to the measured power level, and determines the energy-saving network node for waking up based on the location of the apparatus.

12. The method of claim 10, further comprising:
transmitting, by the processor in the first scheme, a handover command to the apparatus when the apparatus is in a connected mode;
transmitting, by the processor in the first scheme, a first termination for a recovery process to the apparatus when the PRACH for the sequence corresponds to the recovery process and the apparatus is in the connected mode; or
transmitting, by the processor in the first scheme, a second termination for a random access channel (RACH) update process or a Timing Advance (TA) process to the apparatus when the PRACH for the sequence corresponds to the RACH update process or the TA process and the apparatus is in an idle mode or in the connected mode.

13. The method of claim 10, wherein when the second scheme is utilized, the serving network node broadcasts the nearby information indicating a RACH information, and the apparatus determines the energy-saving network node based on the nearby information and transmits the preamble based on a configuration of the RACH information to the energy-saving network node for waking up.

14. The method of claim 10, wherein when utilizing the second scheme to wake up the energy-saving network node based on the mapping information, the energy-saving network node receives at least one of an urgency indication, a nearby indication, and an access assistance indication by the preamble from the apparatus, the urgency indication indicates a small power level of the measured RS, the nearby indication indicates a nearby beam to the energy-saving network node, and the access assistance indication indicates how to respond to the apparatus based on a relative location of the apparatus.

15. A method, comprising:
receiving, by a processor of an energy-saving network node, a waking-up indication based on a first scheme or a second scheme, wherein the energy-saving network node is in an inactive mode; and
waking up, by the processor, from the inactive mode based on the waking-up indication to serve an apparatus of a wireless network.

16. The method of claim 15, wherein the first scheme comprises an indirect scheme that the energy-saving network node is waked up by a serving network node based on a sequence transmitted by the apparatus via a physical random access channel (PRACH) and a system information (SI) transmitted by the serving network node, and the second scheme comprises a direct scheme that the energy-saving network node is waked up by the apparatus based on a preamble transmitted by the apparatus and a nearby information broadcasted by the serving network node.

17. The method of claim 16, wherein the SI indicating a sequence information is transmitted from the serving network node to the apparatus, and the sequence information comprises a mapping information for a measured reference signal (RS) and a measured power level.

18. The method of claim 17, wherein the receiving of the waking-up indication comprises:
receiving, by the processor in the first scheme, the waking-up indication from the serving network node for waking up,
wherein the serving network node determines a location of the apparatus based on a direction mapping corresponding to the measured RS and a distance mapping corresponding to the measured power level, and determines the energy-saving network node for waking up based on the location of the apparatus.

19. The method of claim 16, wherein the receiving of the waking-up indication comprises:
receiving, by the processor in the second scheme, the preamble via the PRACH from the apparatus for waking up,
wherein the serving network node broadcasts the nearby information indicating a RACH information, and the apparatus determines the energy-saving network node based on the nearby information and transmits the preamble based on a configuration of the RACH information to the energy-saving network node.

20. The method of claim 16, wherein the receiving of the waking-up indication comprises:
receiving, by the processor in the second scheme, at least one of an urgency indication, a nearby indication, and an access assistance indication by the preamble from the apparatus, wherein the urgency indication indicates a small power level of a measured reference signal (RS), the nearby indication indicates a nearby beam to the energy-saving network node, and the access assistance indication indicates how to respond to the apparatus based on a relative location of the apparatus.
